(19) United States
(12) Patent Application Publication
(10) Pub. No.: US 2014/0344389 A1
(43) Pub. Date: Nov. 20, 2014

(54) SERVER HAVING MULTIPLE NODES AND METHOD FOR DYNAMICALLY SETTING MASTER NODE OF THE SERVER

(71) Applicant: HON HAI PRECISION INDUSTRY CO., LTD., New Taipei (TW)

(72) Inventor: CHUNG-JEN HSIEH, New Taipei (TW)

(73) Assignee: HON HAI PRECISION INDUSTRY CO., LTD., New Taipei (TW)

(21) Appl. No.: 14/279,333

(22) Filed: May 16, 2014

(30) Foreign Application Priority Data
May 17, 2013 (TW) 102117510

(51) Int. Cl. H04L 12/28; G06F 13/362

(52) U.S. Cl. CPC H04L 12/2894; G06F 13/362
USPC 709/208

(57) ABSTRACT

A server having multiple nodes and a method for dynamically setting a master node of the server are provided. Each node includes a board management controller (BMC), and one of the nodes is preset to be a current master node of the server. The server further includes an I2C multiplexer respectively coupled to the BMC of each node through an IPMB channel, and an embedded module coupled to the I2C multiplexer. The embedded module communicates with the BMC of the current master node through the I2C multiplexer and the IPMB channel, and obtains status information of the current master node, to determine whether the current master node runs normally. If the current master node runs abnormally, the embedded module enables an IPMB channel between the I2C multiplexer and another one of the nodes, to set another one of the nodes to be a new master node of the server.

### FIELD

The subject matter herein generally relates to a server, and particularly to a server having multiple nodes and a method for dynamically setting a master node of the server.

### BACKGROUND

A server having multiple nodes is built for power management, power protection, and thermal management. An unchangeable master node is selected from the multiple nodes and is set for the server.

### BRIEF DESCRIPTION OF THE DRAWINGS

Implementations of the present disclosure will now be described, by way of example only, with reference to the attached figures, wherein:

FIG. 1 is a schematic diagram of one embodiment of a server.

FIG. 2 is a flowchart illustrating a method for dynamically setting a master node of the server of FIG. 1.

FIG. 3 is a flowchart illustrating a method for power management adapted for the server of FIG. 1.

FIG. 4 is a flowchart illustrating a method for power protection adapted for the server of FIG. 1.

FIG. 5 is a flowchart illustrating a method for thermal management adapted for the server of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a server having multiple nodes and a method for dynamically setting a master node of the server. Each one of the nodes comprises a board management controller (BMC), and one of the nodes is preset to be a master node of the server. The server further includes an I2C multiplexer respectively coupled to the BMC of each node through an intelligent platform management bus (IPMB) channel, and an embedded module coupled to the I2C multiplexer and configured to enable the IPMB channel between the I2C multiplexer and the current master node. The embedded module communicates with the BMC of the current master node through the I2C multiplexer and the IPMB channel, and obtains status information of the current master node from the BMC of the current master node, to determine whether the current master node runs normally. If the embedded module determines that the current master node runs abnormally, the embedded module enables an IPMB channel between the I2C multiplexer and one of the nodes, to set another one of the nodes to be a new master node of the server.

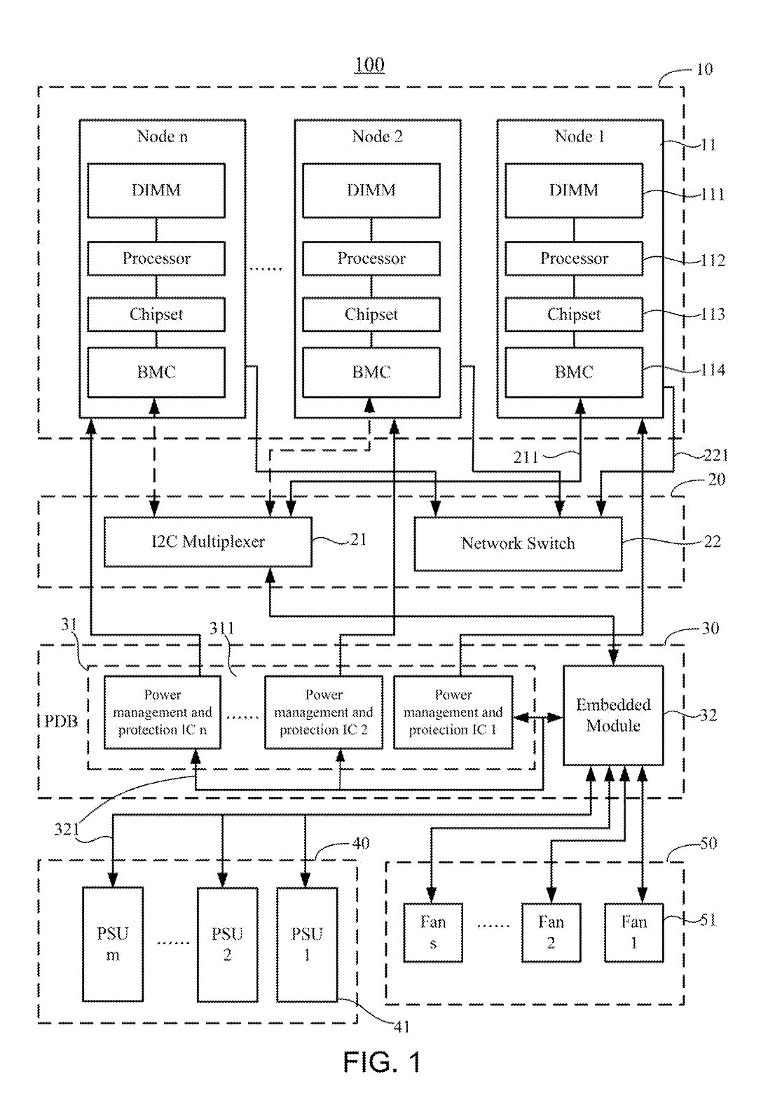

FIG. 1 is a schematic diagram of one embodiment of a server 100. The server 100 includes a node module 10, a mid-plane 20, and a power distribution board (PDB) 30.

In the embodiment, the node module 10 includes a number of nodes 11, each node 11 is a motherboard, and includes a dual inline memory module (DIMM) 111, a processor 112, a chipset 113, and a BMC 114. In the embodiment, one of the nodes 11, such as the node 1, is preset to be a current master node of the server 100.

The server 100 further includes an I2C multiplexer 21 distributed on the mid-plane 20 and respectively coupled to the BMC 114 of each one of the nodes 11 through an IPMB channel 211.

The server 100 further includes an embedded module 32 distributed on the PDB 30, which is coupled to the I2C multiplexer 21, and is configured to enable the IPMB channel 211 between the I2C multiplexer 21 and the current master node 11.

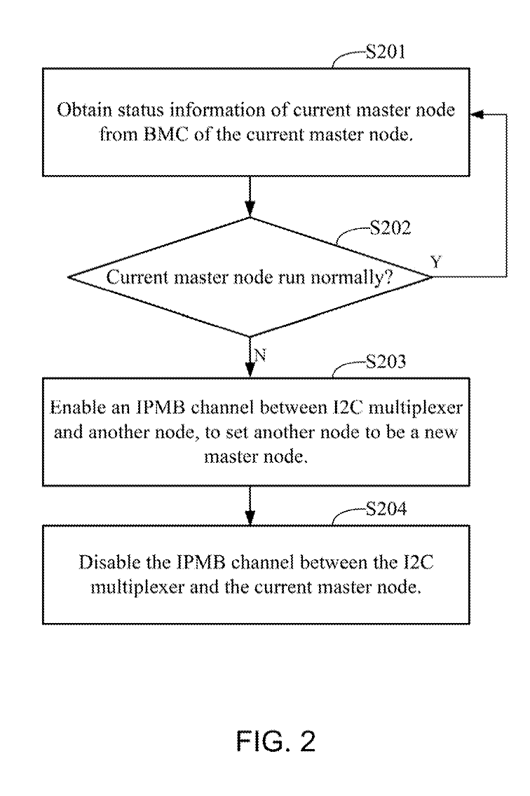

FIG. 2 is a flowchart illustrating a method for dynamically setting a master node of a server from multiple nodes.

In block 201, an embedded module communicates with the BMC of a current master node through an I2C multiplexer and an IPMB channel, and obtains status information of the current master node from the BMC of the current master node.

In block 202, the embedded module determines whether the current master node runs normally, if the embedded module determines that the current master node runs normally, the procedure returns to block 201. If the embedded module determines that the current master node runs abnormally, the procedure goes to block 203.

In block 203, the embedded module enables an IPMB channel between the I2C multiplexer and another one of the multiple nodes, to set another one of the multiple nodes to be a new master node of the server.

In block 204, the embedded module further disables the IPMB channel between the I2C multiplexer and the current master node.

FIG. 1 illustrates that the server 100 further includes a network switch 22, such as an Ethernet switch, distributed on the mid-plane 20, and respectively coupled to the BMC 114 of each one of the nodes 11 through a local area network (LAN) channel 211. The network switch 22 and the BMCs 114 of the nodes 11 are coupled together to form a LAN, and the BMCs 114 of the nodes 114 can communicate with each other through the network switch 22.

The server 100 further includes a power management and protection module 31 distributed on the mid-plane 20. The power management and protection module 31 includes a number of power management and protection ICs 311. Each of the power management and protection ICs 311 is coupled to one of the nodes 11, and is configured for power management and protection of the corresponding node 11.

The server 100 further includes a power supply module 40 and a fan module 50. The power supply module 40 includes a number of power supply units (PSUs) 41 configured to supply power for the server 100. In the embodiment, the embedded module 32 is respectively coupled to each of the power management and protection ICs 311 and the PSUs 41 through a power management bus (PMB) channel 321. The fan module 50 includes a number of fans 51 configured for heat dissipation. Each fan 51 is coupled to the embedded module 32.

In the embodiment, the embedded module 32 can further obtain power consumption information of the server 100 from each of the power management and protection ICs 311 and the PSUs 41, and send the power consumption information of the server 100 to the BMC 114 of the current master node 11 through the IPMB channel 211. The BMC 114 of the current master node 11 can obtain power information of the current master node 11, and obtain power information of each BMC 114 of each of the other nodes 11 through the LAN channels 211. The BMC 114 of the current master node 11 can further determine a power management solution for the server 100 based on the power consumption information of the server 100 and the power information of all of the nodes 11.

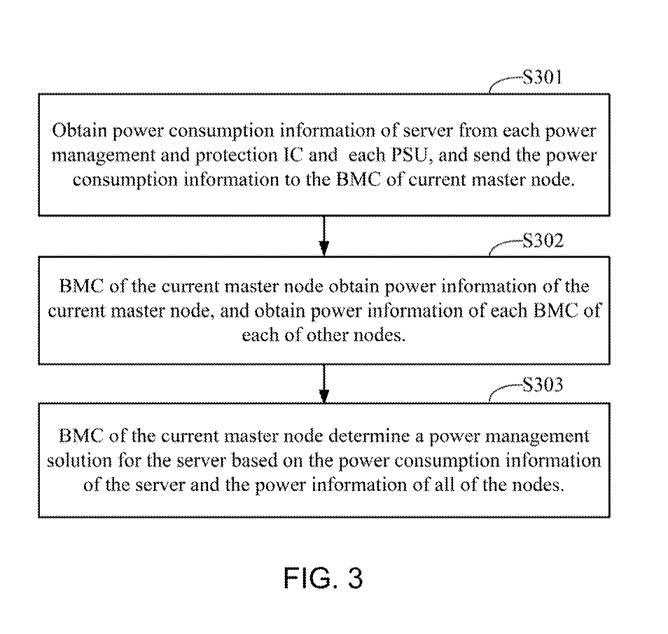

FIG. 3 is a flowchart illustrating a method for power management adapted for a server.

In block 301, the embedded module obtains power consumption information of the server from each of the power management and protection ICs and the PSUs, and sends the power consumption information of the server to the BMC of the current master node through the IPMB channel.

In block 302, the BMC of the current master node obtains power information of the current master node, and obtains power information of each BMC of each of the other nodes through the LAN channels.

In block 303, the BMC of the current master node determines a power management solution for the server based on the power consumption information of the server and the power information of all of the nodes.

In the embodiment, the embedded module 32 can further obtain power information from each of the power management and protection ICs 311, the PSUs 41 and the fans 51, and send the power information to the BMC 114 of the current master node 11 through the IPMB channel 211. The BMC 114 of the current master node 11 can obtain status information of the current master node 11, and obtain status information of the other nodes 11 through the LAN channels 211. The BMC 114 of the current master node 11 can further determine whether the status of each of the nodes 11 is normal based on the power information and the status information of all of the nodes 11. If the status of one or more of the nodes 11 is abnormal, the BMC 114 of the current master node 11 can further report the abnormal statuses of one or more of the nodes 11 to the embedded module 32. The embedded module 32 can further control a corresponding power management and protection IC 311 to cut off power supplied to the abnormal node 11.

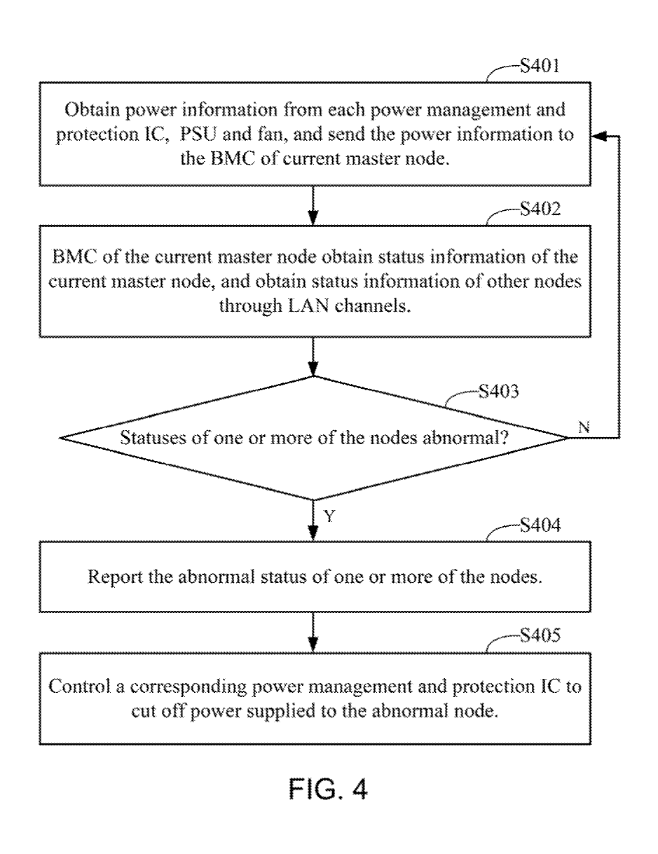

FIG. 4 is a flowchart illustrating a method for power protection adapted for a server.

In block 401, the embedded module obtains power information from each of the power management and protection ICs, the PSUs and the fans, and sends the power information to the BMC of the current master node through the IPMB channel.

In block 402, the BMC of the current master node obtains status information of the current master node, and obtains status information of the other nodes through the LAN channels.

In block 403, the BMC of the current master node determines whether the status of each of the nodes is normal based on the power information and the status information of all of the nodes. If the statuses of all of the nodes are normal, the procedure returns to block 401. If the status of one or more of the nodes is abnormal, the procedure goes to block 404.

In block 404, the BMC of the current master node reports the abnormal status of one or more of the nodes to the embedded module.

In block 405, the embedded module controls a corresponding power management and protection IC to cut off power supplied to the abnormal node.

In the embodiment, the BMC 114 of each of the nodes 11 can obtain temperature information of the node 11, and calculate a pulse width modulation (PWM) data for each of the fans 51. The BMC 114 of the current master node 11 can further obtain the PWM data calculated by other nodes 11 through the LAN channels 211, compare the PWM data calculated by all of the nodes 11, and send the PWM data which has a maximum value to the embedded module 32 through the IPMB channel 211. The embedded module 32 can further receive and send the PWM data, which has a maximum value to each of the fans 51, to control the fans 51 to operate based on the PWM data, which has a maximum value.

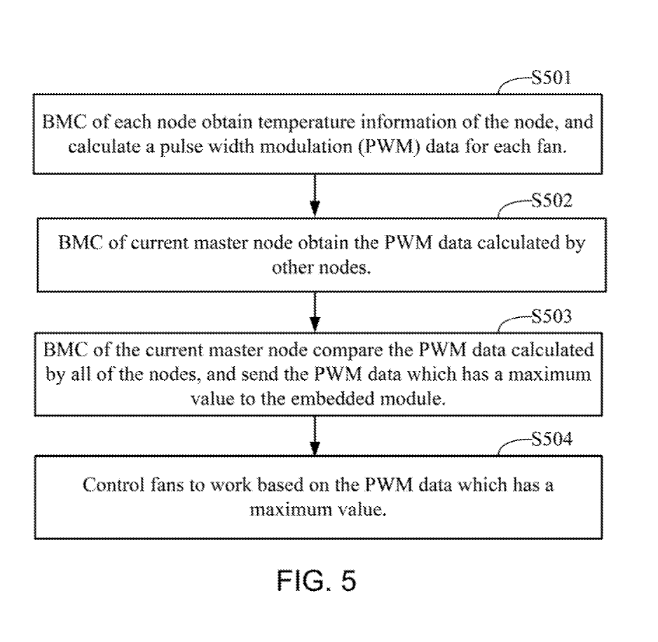

FIG. 5 is a flowchart illustrating a method for thermal management adapted for a server.

In block 501, the BMC of each of the nodes obtains temperature information of the node, and calculates a PWM data for each of the fans.

In block 502, the BMC of the current master node obtains the PWM data calculated by other nodes through the LAN channels.

In block 503, the BMC of the current master node compares the PWM data calculated by all of the nodes, and sends the PWM data, which has a maximum value to the embedded module through the IPMB channel.

In block 504, the embedded module receives and sends the PWM data, which has a maximum value to each of the fans, to control the fans to operate based on the PWM data, which has a maximum value.

The embodiments shown and described above are only examples. Many details are often found in the art such as the other features of a server. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A server (100) comprising:
a plurality of nodes (11), each one of which comprising a board management controller (BMC, 114), wherein one of the nodes (11) is preset to be a current master node of the server (100);
an I2C multiplexer (21) respectively coupled to the BMC (114) of each one of the nodes (11) through an intelligent platform management bus (IPMB) channel (211); and
an embedded module (32) coupled to the I2C multiplexer (21), and configured to enable the IPMB channel (211) between the I2C multiplexer (21) and the current master node (11);
wherein the embedded module (32) is further configured to communicate with the BMC (114) of the current master node (11) through the I2C multiplexer (21) and the IPMB channel (211), and obtain status information of the current master node from the BMC (114) of the current master node (11), to determine whether the current master node (11) runs normally; and if the embedded module (32) determines that the current master node (11) runs abnormally, the embedded module (32) is further configured to enable an IPMB channel (211) between the I2C multiplexer (21) and another one of the nodes (11), to set another one of the nodes (11) to be a new master node of the server (100).

2. The server (100) as described in claim 1, wherein the embedded module (32) is further configured to disable the IPMB channel (211) between the I2C multiplexer (21) and the current master node (11) if the embedded module (32) determines that the current master node (11) runs abnormally.

3. The server (100) as described in claim 1, further comprising:
a network switch (22) respectively coupled to the BMC (114) of each one of the nodes (11) through a local area network (LAN) channel (211);
a plurality of power management and protection ICs (311) each coupled to one of the nodes (11), and configured for power management and protection of the corresponding node (11);
a plurality of power supply units (PSUs, 41) configured to supply power for the server (100); and
a plurality of fans (51) configured for heat dissipation;
wherein the embedded module (32) is respectively coupled to each of the power management and protection ICs (311), the PSUs (41), and the fans (51).

4. The server (100) as described in claim 3, wherein the embedded module (32) is further configured to obtain power consumption information of the server (100) from each of the power management and protection ICs (311) and the PSUs (41), and send the power consumption information of the server (100) to the BMC (114) of the current master node (11) through the IPMB channel (211);
the BMC (114) of the current master node (11) is configured to obtain power information of the current master node (11), and obtain power information of each BMC (114) of each of the other nodes (11) through the LAN channels (211); and
the BMC (114) of the current master node (11) is further configured to determine a power management solution for the server (100) based on the power consumption information of the server (100) and the power information of all of the nodes (11).

5. The server (100) as described in claim 3, wherein the embedded module (32) is further configured to obtain power information from each of the power management and protection ICs (311), the PSUs (41) and the fans (51), and send the power information to the BMC (114) of the current master node (11) through the IPMB channel (211);
the BMC (114) of the current master node (11) is configured to obtain status information of the current master node (11), and obtain status information of the other nodes (11) through the LAN channels (211);
the BMC (114) of the current master node (11) is further configured to determine whether the status of each of the nodes (11) is normal based on the power information and the status information of the nodes (11);
if the statuses of one or more of the nodes (11) is abnormal, the BMC (114) of the current master node (11) is further configured to report the abnormal statuses of one or more of the nodes (11) to the embedded module (32);
the embedded module (32) is further configured to control a corresponding power management and protection IC (311) to cut off power supplied to the abnormal node (11).

6. The server (100) as described in claim 3, wherein the BMC (114) of each of the nodes (11) is configured to obtain temperature information of the node (11), and calculate a pulse width modulation (PWM) data for each of the fans (51);
the BMC (114) of the current master node (11) is further configured to obtain the PWM data calculated by other nodes (11) through the LAN channels (211), compare the PWM data calculated by all of the nodes (11), and send the PWM data which has a maximum value to the embedded module (32) through the IPMB channel (211); and
the embedded module (32) is further configured to receive and send the PWM data, which has a maximum value to each of the fans (51), to control the fans (51) to operate based on the PWM data, which has a maximum value.

7. A method for dynamically setting a master node of a server having a plurality of nodes, wherein each one of the nodes comprises a BMC, and one of the nodes is preset to be a current master node of the server; wherein the server further comprises an I2C multiplexer respectively coupled to the BMC of each one of the nodes through an IPMB channel, and an embedded module coupled to the I2C multiplexer and configured to enable the IPMB channel between the I2C multiplexer and the current master node; the method comprising:
communicating with the BMC of the current master node through the I2C multiplexer and the IPMB channel, and obtaining status information of the current master node from the BMC of the current master node, using the embedded module;
determining whether the current master node runs normally based on the status information of the current master node, using the embedded module;
if the embedded module determines that the current master node runs abnormally, enabling an IPMB channel between the I2C multiplexer and another one of the nodes using the embedded module, to set another one of the nodes to be a new master node of the server.

8. The method as described in claim 7, further comprising:
disabling the IPMB channel between the I2C multiplexer and the current master node if the embedded module determines that the current master node runs abnormally.
